(19) United States
(12) Patent Application Publication
(10) Pub. No.: US 2024/0354816 A1
(43) Pub. Date: Oct. 24, 2024

(54) System and Method for Automatic and/or Manual Chat Routing

(71) Applicant: Livechat Software S.A., Wroclaw (PL)

(72) Inventor: Marcin Dojwa, Wroclaw (PL)

(73) Assignee: Livechat Software S.A., Wroclaw (PL)

(21) Appl. No.: 18/136,486

(22) Filed: Apr. 19, 2023

(51) Int. Cl. G06Q 30/02

(52) U.S. Cl. CPC G06Q 30/0281

(57) ABSTRACT

The present disclosure provides a system and method for intelligent chat routing. The high responsiveness required for instant messaging makes the assignment of a particular message to the most available agent a crucial element of service providing. The invention enables chat to be transferred to all logged agents from the group to which the chat is assigned and further to adjust the regular functioning of the system with regard to the acceptance or not of new incoming chats. Chat can be transferred to all groups in which at least one other agent is available (in counter only agents accepting chats except the current agent are taken into account), or if the queue limit is exceeded then chat is not started the invention displays the component enabling ticket set up (for asynchronous communication) that shall be further synchronized with the ticketing system.

### BACKGROUND OF THE INVENTION

One of the most well-known and often utilized forms of customer support is instant messaging. The systems mentioned, like chat channels, are real-time message exchanges taking place via a computer network. Delivering customer care in real-time while having an online interaction has certain complications. Real-time messaging calls for a high level of reaction, among other things, and unlike traditional kinds of communication, like email, customers now want precise instructions, comments, and the like within a few seconds of the initial inquiry.

Currently available chat solutions are mostly delivering two types of service: real time and asynchronous. Nevertheless, such solutions fail to include a more detailed scope of routing between the chatting agents so as to provide better efficiency of and for delivered customer service while maximizing the possibility of receiving an adequate response from the agent.

The idea of assigning the chat to the most adequate agent includes the element of evaluation and assessment of the chatting agent. Considerations for the same may include an average response time, average likelihood to close the chat conversation within as limited a time as possible, and a requirement of a satisfaction ratio that avoids excessive queues. Provided invention address the need of intelligent chat routing based on both standardized efficiency assessment as well as manually predefined conditions set by the user. The present invention is directed towards instant communication and conversations routing to provide better and more efficient service.

### BRIEF SUMMARY OF THE INVENTION

The present invention is directed to a system and method for automatic and/or manual chat routing. Instant communication channels such as instant messaging have become one of the most popular ways of communication between businesses and customers. However, delivering customer care in real-time while having an online interaction can be challenging. The invention addresses the need for intelligent chat routing based on standardized efficiency assessment and manually predefined conditions set by the user. The present invention includes a system and method that enables intelligent routing based on predefined conditions such as queue to a particular agent, geolocation, time zone, efficiency score, and/or other parameters collected about the particular agent or type of conversation.

Depending on the set up of the particular embodiment of the invention, the chat can be transferred to all logged agents from the group to which the chat is assigned. Consequently, the invention adjusts the regular functioning of the system with regard to acceptance, or not, of new incoming chats. Chat routing helps streamline internal communication for teams by ensuring that messages are sent to the right individuals or groups, and by improving collaboration and productivity. Additionally, chat routing improves customer experience by directing inquiries to appropriate departments or agents, while providing personalized support and improving the overall experience. A limit that defines availability of chat routing may be defined either by a hard limit, such as the user of the embodiment indicating a maximum limit of chats per whole organization or agent being not greater than or equal to a particular amount. Alternatively, a limit may be based on efficiency scoring, such as an average response time contrasted with a number of tickets. Individual scoring may also be set up by other defining parameters, such as a number of tracked visitors on a dedicated site where the chat widget connected to the disclosed system is located.

Assignment based on automated routing may include the following options based on the choice of the embodiment user (agent). For a new visitor, a chat shall be assigned to the first available agent chosen by round-robin. Agents with “primary” priority are taken before agents with “secondary” priority. Agents with the same priority are taken first if they have fewer active chats. If all agents have the same count of active chats, the agent who started their shift earlier is taken first. In conclusion, the invention provides a system and method for automatic and/or manual chat routing, which addresses the need for intelligent chat routing based on standardized efficiency assessment and manually predefined conditions set by the user. The invention has the potential to improve customer experience, streamline internal communication for teams, and improve collaboration and productivity.

### DESCRIPTION OF THE SEVERAL VIEWS OF DRAWINGS

Further advantages features and details of the various embodiments of this disclosure will become apparent from the ensuing description of a preferred exemplary embodiment or embodiments and further with the aid of the drawings. The features and combinations of features recited below in the description, as well as the features and feature combination shown after that in the drawing description or in the drawings alone, may be used not only in the particular combination recited but also in other combinations on their own without departing from the scope of the disclosure.

In the following, advantageous examples of the disclosure are set out with reference to the accompanying drawings, wherein:

FIG. 1 discloses the simplified method steps regarding the assignment of the chat by chat routing wherein the agent is available or the agent is not available and a further step of assignment is being performed;

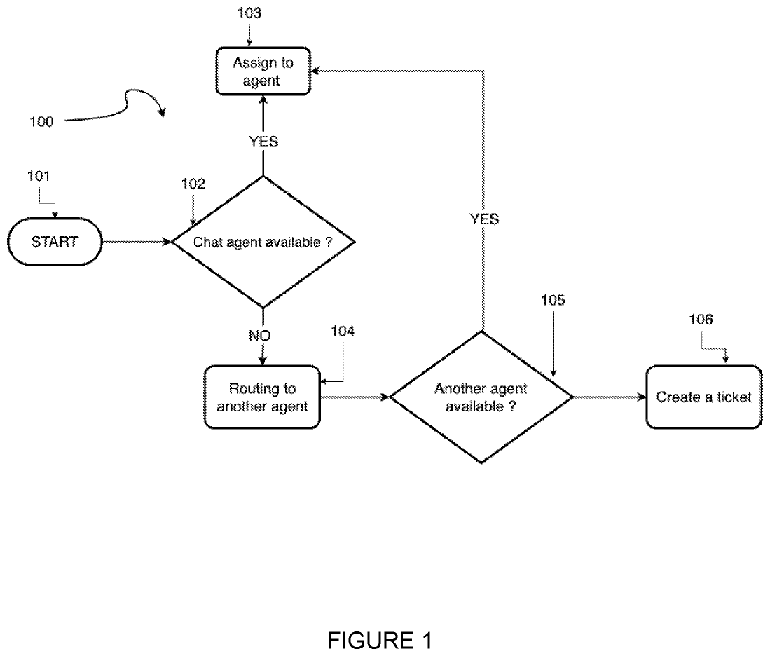

FIG. 2 discloses the full scope of method steps regarding the assignment of the chat by chat routing wherein the last chatting agent is agent is available or the last chatting agent is not available and a further step of assignment is being performed;

FIG. 3 discloses the simplified method steps regarding the assignment of the chat by chat routing wherein the agent is available or the agent is not available and a further step of queue creation is being performed; and

FIG. 4 discloses the overview of system elements necessary to perform method steps.

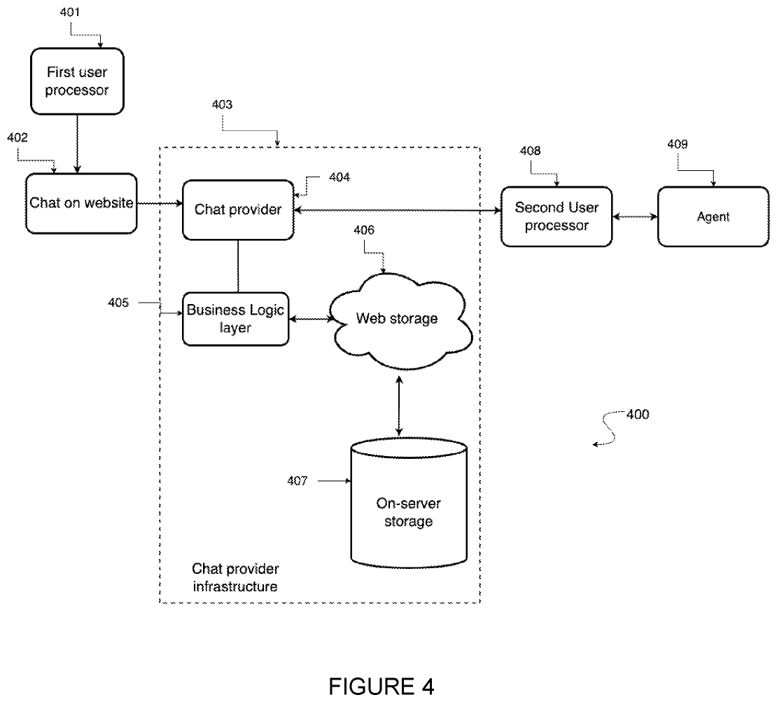

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C. In the figures, the same or functionally identical elements have been provided with the same reference signs.

Instant communication channels are a popular way of communicating between business providers and customers/potential customers. Because instant messaging requires high-responsive reactions, assignment of a particular message to an available agent is a crucial element of service provision. Instant chat routing is a necessary feature for chat communication because it allows messages to be delivered quickly and efficiently to the appropriate recipient. Without this feature, messages may end up in the wrong conversation or with the wrong person, leading to confusion and delays in communication. Instant chat routing also enables companies to provide better customer service by directing inquiries to an appropriate department or agent. By automating the routing process, customers receive faster and personalized support, improving their overall experience. Additionally, chat routing helps streamline internal communication for teams by ensuring that messages are sent to the right individuals or groups, and by improving collaboration and productivity. As a consequence, instant chat routing is an essential feature for effective and efficient communication in today's fast-paced digital world.

An embodiment of the present invention refers to system and method steps enabling intelligent routing based on predefined conditions, including queuing for a particular agent, geolocation, time zone, efficiency score and/or other predefined parameter(s) collected in regard to at least a particular agent and/or type of conversation at hand. In particular, the possibility of queueing may happen in two circumstances:
where chat is assigned to a group with one chat agent—then the queue is created for this particular agent only; and
where chat is assigned to a group with more than one chat agent—the queue is created for a group of agents and the chat is assigned to an agent from the group who began his/her chat earlier than any of the other agents, thus raising the likelihood that the earliest chat starting agent may pick up the queue assigned conversation on short notice.
   Another possibility of queuing refers to the geolocation of a chat agent where the chat is being assigned to a group of agents with the highest proximity of geolocation to the end user who enters the chat. The aforementioned rule regarding the queue in the case of at least one chat agent in the group or plurality of chat agents applies here as well.

Definition of the availability of chat agents in a group may be further supplemented by the work schedule according to the time zone of each agent. In such case, the chat is being assigned to the agent from a group that has the working hours according to the registered time zone open at the time when the chat is incoming.

Depending on the individual set up of the embodiment of the invention, a chat can be transferred to all logged agents from the group to which the chat is assigned (independent from accepting chats status and active chats limit). Consequently, described invention embodiments may adjust the regular functioning of the system with regard to the acceptance or not of new, incoming chats. What is more, a chat can be transferred to all groups in which at least one other agent is available (in counter only agents accepting chats except current agent are taken into account) or if the queue limit is exceeded then the chat is not started and the instant system and method may display the component enabling ticket set up (for asynchronous communication) that shall be further synchronized with the internal or external ticketing system depending on the individual set up and availability. Once the end-user starts the communication via entering the chat widget (101), the system checks if there is an agent available (102), and if the agent that was speaking with the end-user a last time as based upon the chat history of the chat conversation, is being assigned to be a particular agent (103). If there is no agent that fulfills the criteria of qualification available then the chat is being routed to another agent (104). If there is another agent available (105), the chat is being assigned to the agent (103). Once there is no possibility to assign the chat to an agent (105), the system enables the user to create a ticket (106).

Furthermore, the limit that defines the availability of chat routing may be defined either by the hard limit where the user of the embodiment states that maximum limit of chats per whole organization or an agent is not greater than or equal to a particular number. On the other hand, the limit may be based on the efficiency scoring, as for example, based on the average time response contrasted against tickets number. Individual scoring may be also set up by other defining parameters as a number of tracked visitors on a dedicated site where the chat widget connected to the disclosed system is located. When the number of visiting customers using a web widget is above this limit then the possibility of routing the chat is excluded and the possibility of ticket set up is the only possible option of contact with the company.

A next embodiment of the present invention refers to the assignment of the chat conversation to the agent while there is a new visitor and a currently known visitor (history of prior chat). Assignment based on the automated routing may further include the following options based on the choice of the embodiment user (agent). For a new visitor, the chat shall be assigned to the first available agent chosen by round robin:
the agent is online, accepts chats, has a free slot, and belongs to a group;
agents with “primary” priority are taken before agents with “secondary” priority (priority is set in a group addition in agents/group tab: by default, a newly added agent may always have primary priority); and
agents with the same priority->agents with fewer active chats are taken first or if all agents have the same count of active chats, then the agent which start chat earliest is selected.

For a returning visitor:
if there is an agent which was chatting before with visitor then chat goes to him; and
if no, then rules from point 2 are taken into account.

If there is no agent with free chat slots then the chat goes into a queue.

With regard to the transfer of chats between the agents, a next embodiment of the invention discloses the chat being automatically assigned to a chosen agent independent of his or her activity (accept/don't accept chats) and current active chat count.

With regard to the transfer of chats between the agents, a next embodiment of the invention discloses the chat being transferred between groups that further includes the elements of:
if the same group is chosen, then the chat is assigned to an agent which wasn't assigned to a group during the current chat thread;
   if all agents have chat already, then the chat goes to queue and when a new agent appears in group then he or she gets that chat;
   if a chat is transferred to another group, then the assignment list is cleaned;
      i. a chat is not assigned to the same agent during the first transfer to a new group if an agent is available in a new group; and
      ii. if there is a next transfer into a new group, then the chat can be assigned to an agent which was transferring chat to that group.

Consequently, the above-described method steps assume the three elements sequence: defining the status of the chat (new or returning), defining the availability of agents and defining the possibility of relocation between groups of chat agents.

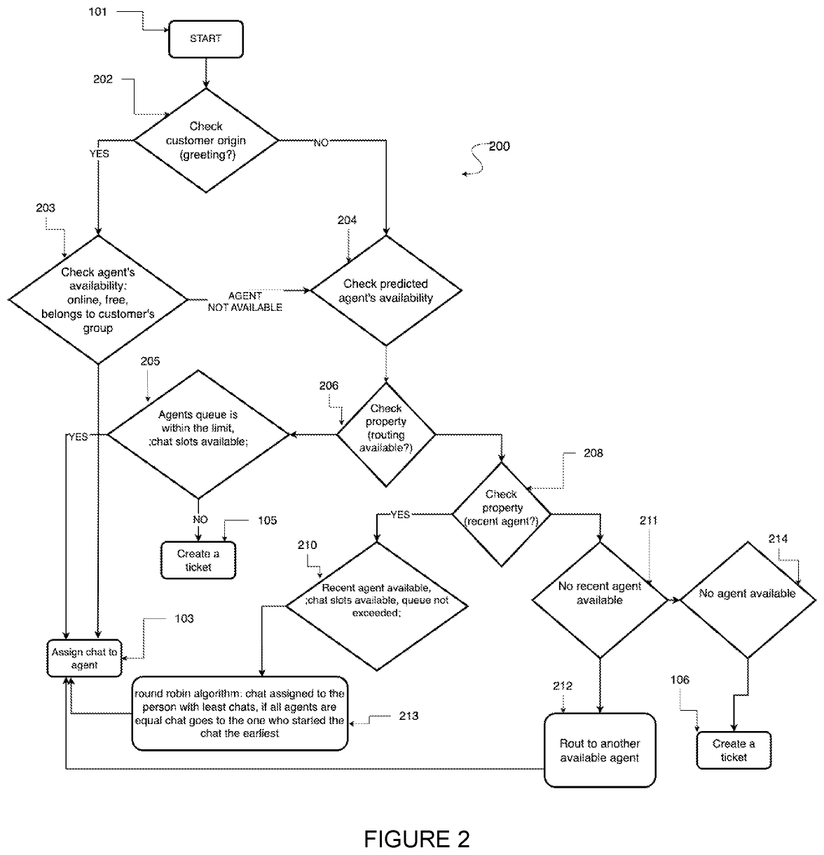

A next embodiment of the invention as disclosed by FIG. 2 and includes the pre-qualification of an incoming chat by the characteristics of greeting (202). If the visitor has been welcomed with a greeting from a particular agent, then the system attempts to assign the chat conversation to the agent based on the predicted availability of the agent (204). Further, the embodiment of the invention checks if the chat routing option is being enabled for the agent (206) and checks the properties of the agent based on the latest-(to be)-in-touch with the client (208). If there is an agent with availability (210) that according to the definition of the queue can accept incoming chats, the embodiment assigns the chat to the agent (103) with the implied use of the round robin algorithm (213) where the chat conversation assigned to the person with a least amount of chats, and if all agents are equal, the chat goes to the one who started the chat at the earliest. If there is no agent that fulfills previous criteria (211), then the embodiment of the invention attempts to rout to another available agent (213). If such routing is successful then the agent is assigned to the chat conversation (103). If there is no ability to assign to any agent (214), then the embodiment of the invention enables a ticketing process (105), wherein, by the ticketing process, it is understood that the system enables integration with the external or internal ticketing system via the chat provider infrastructure (403).

A next embodiment of the invention includes the possibility of a manual chat routing set up. In this regard, when that option is chosen, then chats which are started by a customer shall always go to the end of the queue for all agents in a group to which the chat is assigned when the agent sees new queued chat at the end of the list of all his chats (chats from different groups are mixed—order depends on time in queue). Also, when the agent starts a chat from the customer list (Start Chat action), then the chat is automatically assigned to him without a queue and upon the selection of an adequate settings option. Lastly, there is a group of functionalities that are not taken into account when the option of automatic chat assignment is being performed, namely: bots (a chat goes to a bot only by direct transfer from another agent so as to avoid a lowered customer service efficiency), as well as greetings (previous greetings settings are still stored in the database but their use in the communication channel may be limited due to automatic chat routing to avoid repetitiveness).

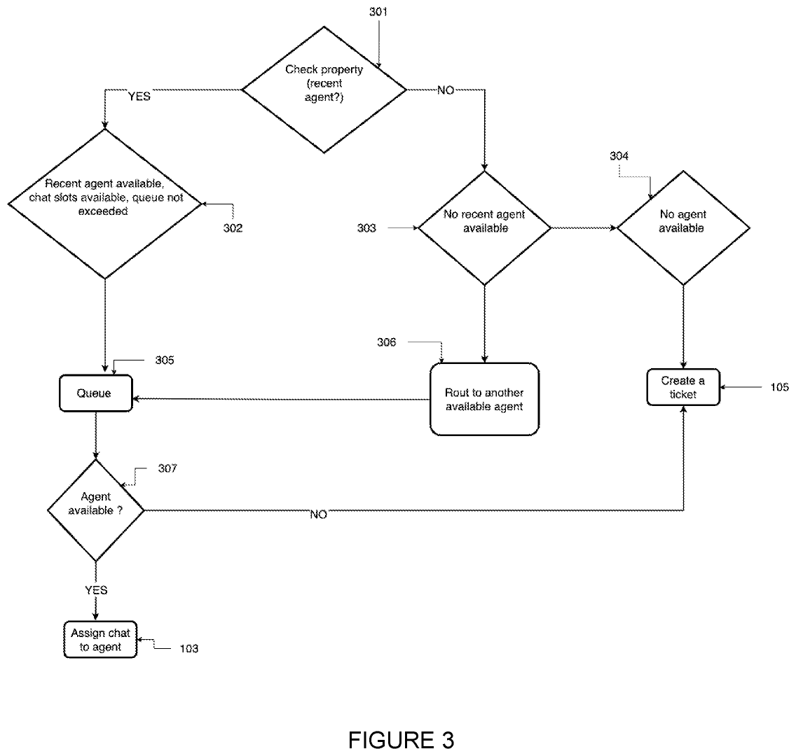

A next embodiment of the invention refers to the creation of the queue disclosed by FIG. 3. This embodiment of the invention checks the availability of a recent agent to and for the incoming chat from the end user (301). If there is no recent agent available (303), then the system attempts to queue the chat to another agent (306). If the agent's availability is not instant (free to accept the incoming chat at the moment) but the queue is within the predefined limit as saved in the chat provider infrastructure (404), then the embodiment of the invention creates a queue to a particular agent or a group of agents depending on the type of set up (405). Once the agent from a group or particular agent becomes available (307) the chat is assigned (103). In the case where there is no available agent or a group of agents that the chat conversation may be queued to (304), the embodiment of the invention enables the creation of a ticket option (105) that is further assigned to the agent (103) to respond in an asynchronous manner.

A next element of the embodiment of the invention focuses on the possibility of the assignment of the incoming chat based on the URL parameter. With this regard, the main focus of the invention is to either detect the definition parameter based on the URL itself or on the cookies that further suggest to which group the chat shall be assigned. By the group one shall understand the unit of chat agents defined as a group to answer the chat. In other words, when a visitor starts a chat, the visitor is being assigned to the right team based on the domain or URL they land on. For example, if the visitor originates from the/pricing subdomain, such chat shall be automatically routed to the Sales team, while when the visitor originates from the/features subdomain, such chat shall be automatically routed to the Support team. Such set up allows efficient scheduling of the work for the team based on the predefined conditions of automatic routing.

The next embodiment of the invention defines chat routing based on geographical location. In such circumstances, the main determining factor is the country of origin. Such conditions allow for the provision of more efficient customer support, especially with regard to time zone or language differences among agents.

The method steps are being further supported by the system(s) and embodiment(s) disclosed by the invention. The operation of chat routing starts with the first user (401) accessing the website with a chat widget installed (402) via the browser configured to operate over the Internet. Once the user accesses the chat widget, it communicates with the chat provider infrastructure which includes a plurality of servers and databases operating to maintain the operation of the method steps (403). The chat provider (404) shares the business logic layer (405) processed on-server to perform the chat routing steps and analyze properties of agents to assign the chat conversation (103) to the most efficiently selected agent.

The storage is further composed of the at least one web storage (406) that is further used for the most frequent data accessed by the user to provide more efficient use of the processing velocity. To access the data least frequently accessed, the embodiment of the invention includes the on-server storage (407) that is further available on demand. Business logic layer (405) assign particular data to the database upon individual frequency of access to the data to provide less interference with the browser processing capacity and reduce redundancy of data retrieving from the database. On the other side of the embodiment of the invention, the agent (409) operates the chat widget and receives the chat assigned by the routing system based on the logic disclosed by the method steps. The agent operates the chat conversation with the second user processor (408). Furthermore, this embodiment of the invention communicates with the ticketing systems (whether internal or external) via an API. The embodiment of the invention includes the API to enable the possibility to and/or for:
CRUD Operations: APIs can enable basic database operations like Create, Read, Update, and Delete (CRUD) using HTTP methods such as GET, POST, PUT, and DELETE;
authentication and authorization: APIs can provide a way to authenticate and authorize users, allowing developers to control access to specific parts of an application or platform whenever it remains necessary due to the safety standards of integration between the ticketing system and chat provider (404);
notifications: APIs can enable real-time notifications for events such as new messages, updates, or changes in the data;
search and filtering: APIs can enable search and filtering functionality to help users find specific data or content within an application or platform; and
analytics: APIs can provide data and metrics on user behavior, usage patterns, and other insights that can help developers optimize their applications.

Since the devices and methods described in detail above are examples of embodiments, they can be modified to a wide extent by the skilled person in the usual manner without departing from the scope of the invention. In particular, the mechanical arrangements and the proportions of the individual elements with respect to each other are merely exemplary. Some preferred embodiments of the apparatus according to the invention have been disclosed above. The invention is not limited to the solutions explained above, but the innovative solutions can be applied in different ways within the limits set out by the claims.

What is claimed is:

1. A method for automatic chat routing, the method comprising the steps of:
starting a chat conversation by at least one end user via chat widget on the website;
defining a status of incoming chat;
checking availability of agents that are online;
assigning the chat conversation to an available chat agent that has been in communication with the user at least once in the past;
determining whether another agent is available within a time period and if the another agent is available assigning the chat conversation to a queue;
routing to the another agent if the agents are not available;
creating a ticket if neither the agents nor the another agent is unavailable; and
wherein the definition of incoming chat may be either new for newly created conversation or returning for the end users that opens the chat widget to continue the conversation;
wherein the step of checking availability further comprises the steps of determining whether at least one of the agents and the another agent are
online
have a queue of chats below predefined limit and
are able to accept incoming chats based on predefined working hours and average efficiency of response.

2. The method according to claim 1, wherein the step of defining the status of incoming chat further comprises the steps of:
checking if there was any communication with a particular end user prior to the incoming communication;
checking if there was any communication with a particular end user prior to the incoming communication assigning the status of returning communication; and
if there was no communication with a particular end user prior to the incoming communication, assigning the status of new communication.

3. The method according to claim 1, wherein the step of checking availability of agents that are online further comprises the steps of:
listing agents that are logged online;
checking a queue status of each agent that is logged online;
selecting the most efficient agent of those logged online, based on predefined conditions set up in a database calculated based on the round robin algorithm;
assigning the chat to the agent;
reassigning the chat to the agent in the case of previously selected agents becoming offline during the course of ongoing chat conversation; and
wherein the step of checking queue status means comparing the maximum queue applicable to the agent according to predefined conditions set up in the database against current amount of pending chats.

4. The method according to claim 1, wherein the step of assigning the chat further comprises the steps of:
checking the status of incoming chat;
checking availability of online agents;
checking if there is availability for chat conversation routing;
checking the work scheduler to determine working hours of the agent;
prioritizing assigning the chat conversation to the agent that has been in communicating with the user beforehand;
selecting another agent based on the efficiency score calculated as the likelihood of responsiveness to the user;
routing the chat conversation to another agent if assigning the chat conversation to the agent that has been in communicating with the user beforehand is not possible;
creating a ticket for the agent for asynchronous communication if it is impossible to rout the chat conversation;
wherein the determination of the first user origin means checking the source of the user path as previously visited websites, geolocation, assignment of the user to a particular agent or group of agents in the database;
wherein checking if there is availability of chat conversation routing is based on the agents available at the moment and on the blacklisted conversation users for particular agent; and
wherein the likelihood of responsiveness to the use is calculated based on the average time response, current length of chat conversations until positive solution, overall chat rating and efficiency score.

5. The method according to claim 1 wherein the step of assigning the chat conversation to the queue if the agent availability is calculated to be upcoming in a short period of time further comprises the evaluation of the time availability of agent that is below the predefined threshold saved in the database by the agent.

6. The method according to claim 1 wherein the step of assigning the chat conversation to the queue if the agent availability further includes the step of creating a queue of chats that are to be assigned to agents as soon as availability occurs.

7. The method according to claim 1 wherein the creating ticket further includes the steps of:
defining the at least one first user details including contact details;
displaying data input where the at least one first user can include message;
saving the at least one first user details including contact details and message in the database;
sending the at least one first user details including contact details and message via API to the external ticketing system;
displaying to the agent information about the ticket created; and
enabling the agent to respond either via chat widget or via email asynchronously.

8. The method according to claim 1 wherein the average efficiency of response is calculated based on the time and velocity of tickets solved by the agent.

9. The method according to claim 6 wherein the step of sending the at least one first user details including contact details and message via API to an external ticketing system comprises the step of exposing the endpoint enabling the ticketing system to receive such data or enabling webhook subscription that proactively send the information about ticket being generated to the ticketing system.

10. A system for at least one of automatic and manual chat routing comprising:
a first user processor configured to operate with the internet browser;
a chat widget configured to display on a website and arranged on a chat provider infrastructure;
a storage arranged on the chat provided infrastructure and configured to save the data of chat conversations;
a second user processor arranged to communicate with the chat widget over the Internet;
an API configured to communicate with external providers including ticketing systems.
wherein the storage includes both web storage and on-server storage; and
wherein the chat widget is configured to operate both real-time and asynchronously.

11. The system according to claim 10 wherein the storage is further comprising:
a web storage configured to operate on the most frequently requested data according to the average accessing frequency;
an on-server storage configured to operate on the least frequently requested data according to the average accessing frequency or on the most processing-consuming data; and
wherein processing-consuming means data means data that due to size or complexity are likely to need more operating power from the server.

12. The system according to claim 10 wherein the chat provider infrastructure is further comprises the server infrastructure responsible for the business logic storage, web storage and on-server storage configured to operate with the chat widget.
